(19) United States
(12) Patent Application Publication
(10) Pub. No.: US 2024/0030576 A1
(43) Pub. Date: Jan. 25, 2024

(54) WAVEGUIDE DEVICE FOR ABSORBING ELECTROMAGNETIC WAVE ENERGY AND METHOD FOR ASSEMBLING SAME

(71) Applicant: APOLLO MICROWAVES, LTD., Dorval (CA)

(72) Inventor: Dominic GAGNÉ, Vaudreuil-Dorion (CA)

(21) Appl. No.: 17/871,263

(22) Filed: Jul. 22, 2022

(51) Int. Cl. H01P 3/12; H01P 11/00

(52) U.S. Cl. CPC H01P 3/12; H01P 11/002

(57) ABSTRACT

A waveguide device is provided to absorb or dissipate electromagnetic waves. The device comprises an elongated housing having a first end that is a power receiving end and a second end, the housing defining a hollow passage. The device also has an elongated absorber element disposed within the hollow passage of the housing along an interior surface of the housing. The elongated absorber element is configured to absorb at least part of electromagnetic waves traveling through the hollow passage. The device also has a projection extending from the elongated housing into the passage. The projection is configured to exert a resilient force on the absorber element to urge the absorber element against the interior surface of the housing. A method for assembling the waveguide device is also provided.

### TECHNICAL FIELD

The present disclosure relates generally to microwave devices and, more particularly, to a waveguide device used for absorbing electromagnetic wave energy, such as waveguide termination devices, and to methods of manufacturing such a device.

### BACKGROUND

In microwave fields, waveguide termination devices are employed to terminate a transmission line with a substantially matched load which is capable of absorbing and dissipating electromagnetic waves (also known as radio frequency (RF) signals) transmitted into the load. As a waveguide termination device prevents electromagnetic waves from reflecting back from open-ended or unused waveguide ports, a reflection, measured in terms of voltage standing wave ratio (VSWR), within the waveguide termination device may be reduced significantly.

Conventionally, in order to provide a substantially matched load in a waveguide system, loads or absorber elements made of different kinds of material or with various shapes may be attached within the waveguide termination device and establish a thermal contact with the housing of the termination device to achieve a desired amount of absorption. Traditional approaches, such as standard brazing or adhesive techniques, are typically used to secure the absorber elements to the waveguide termination device. For example, U. S. Patent U.S. Pat. No. 4,906,952A describes that energy absorbing wedges may be retained in contact with walls of a waveguide with an adhesive. As another example, U.S. Pat. No. 3,904,993A describes that a load may be attached to a waveguide using standard brazing techniques. The contents of the aforementioned documents are incorporated herein by reference.

The housings of the waveguide termination devices are typically made of a material (e.g., aluminum, copper, brass, or bronze) with a relatively high thermal expansion coefficient, the housing of the waveguide termination device may expand longitudinally and/or radially as temperatures of the housing increases. This is particularly present in cases where the waveguide termination devices are used in high-power applications, such as 4 kW or 8 kW continuous-wave (CW) or any suitable carrier wave energy, since a signification amount of heat is generated and must be absorbed. In such cases, the absorber elements secured to the interior surfaces of the housing, for example by brazing or adhesive techniques, may become partially or fully detached as the housing expands longitudinally and/or radially and thus the thermal contact between the absorber elements and the housing is reduced. In addition, as a result of the reduced thermal contact and thus poor heat conductivity, local overheating of the absorber elements, the mechanical fragility of the absorber elements, and/or the expansion of the housing may cause physical damage in the absorber elements, such as brokage or cracking. Thus, performance (e.g., VSWR and/or impedance match) of the waveguide termination device may deteriorate significantly.

Furthermore, in a case when the absorber elements are physical damaged, the entire waveguide termination device may need to be replaced, which leads to increased hardware maintenance costs.

Accordingly, there is a need in the industry to provide an improved waveguide termination device that alleviates at least in part some of the deficiencies of existing waveguide termination devices.

### SUMMARY

This summary is provided to introduce a selection of concepts in a simplified form that are further described below in the Detailed Description. This Summary is not intended to identify all key aspects and/or essential aspects of the claimed subject matter.

In accordance with a first aspect, the present disclosure relates to a waveguide device for absorbing electromagnetic wave energy. The waveguide device comprises one or more projections that extends into a hollow passage of a housing to exert respective resilient forces on one or more absorber elements such that each absorber element is urged against a respective interior side wall of the housing. Since the respective resilient forces caused by the corresponding projection urge the absorber element against the respective interior side wall of the housing, an attachment between the absorber element and the interior side wall is easily removable. The absorber element will no longer deform by expansion impact of the housing's side walls. The side wall may include any interior wall of the housing. In the example of a housing having a rectangular cross section, broad interior walls or narrow interior walls of the housing are referred to as side walls. Thus, physical damages, such as broken or cracking, of the absorber element may be avoided without sacrificing performance of the waveguide device over a wide range of operation frequencies.

In some examples, as the absorber element is removable from the housing of the device, the absorber element may be easily replaced with any other suitable absorber element. Thus, substituting an entire waveguide device may be prevented in a case where the absorber elements have physical damages or when other absorber elements are needed to achieve a desired characteristic of the waveguide device. Therefore, flexibility of manufacturing the waveguide device may be improved, and hardware cost of the waveguide device in a waveguide system may be reduced.

In some applications, the waveguide device may be applied in high power applications, such as medical applications, signal combination, system switch protection, couplers, magic tee, isolator, power test setup.

According to a first example aspect is a waveguide device. The device comprises an elongated housing an elongated housing including a first end and a second end. The first end is a power receiving end. The elongated housing defines a hollow passage. The device further comprises an absorber element that is disposed within the passage of the housing along an interior surface of the housing. The absorber element is configured to absorb at least some energy of the electromagnetic waves traveling through the hollow passage. A projection is also included in the device to extend into the passage. The projection is configured to exert a resilient force on the absorber element to urge the absorber element against the interior surface of the housing.

In accordance with the preceding aspect, the projection extending into the passage is a first projection. The first projection is positioned at a first location along an extent of the elongated absorber element. The waveguide device further comprises a second projection extending from the elongated housing into the passage. The first and second projections are spaced apart from one another. The second projection is positioned at a second location along the extent of the elongated absorber element. The second projection is configured to exert a second resilient force on the elongated absorber element to urge the elongated absorber element against the interior surface of the housing.

In accordance with any of the preceding aspects, the projection extending into the passage is one of a plurality of projections extending from the elongated housing into the passage. The projections in the plurality of projections are positioned at respective locations along an extent of the elongated absorber element. The plurality of projections are spaced apart from one another. The plurality of projections are configured to exert resilient forces on the elongated absorber element to urge the elongated absorber element against the interior surface of the housing. The plurality of projections includes at least three projections.

In accordance with any of the preceding aspects, the plurality of projections are linearly arranged along the hollow passage.

In accordance with any of the preceding aspects, the elongated absorber element has a tapered profile and the plurality of projections are linearly arranged at an angle along the hollow passage. The angle matches the tapered profile of the absorber element.

In accordance with any of the preceding aspects, the housing is made of conductive metal.

In accordance with any of the preceding aspects, the projection is made of conductive metal.

In accordance with any of the preceding aspects, the absorber element is made of lossy material.

In accordance with any of the preceding aspects, the housing and the projection are made of aluminum, copper, brass, bronze, or invar.

In accordance with any of the preceding aspects, the absorber element is made of silicon carbide, ceramic, or lossy resin.

In accordance with any of the preceding aspects, the projection is a part of a distal end of a screw extending from the housing into the hollow passage. The screw is inserted through an aperture formed on an outer surface of the elongated housing so that the part of the distal end of the screw corresponding to the projection extends into the passage.

In accordance with any of the preceding aspects, the screw further includes a proximal end, a threaded component and the distal end, the threaded component being positioned between the proximal end and the distal end, at least a portion of the projection being characterized by a resilience greater than a resilience of the threaded component of the screw thereby being configured for exerting the resilient force on the absorber element.

In accordance with any of the preceding aspects, a diameter of at least the portion of the projection is less than a diameter of the threaded component of the screw.

In accordance with any of the preceding aspects, at least part of the projection is made of first material and wherein the threaded component is made of second material, a modulus of resilience of the first material being higher than a modulus of resilience of the second material.

In accordance with any of the preceding aspects, the projection includes a first portion and a second portion. A diameter of the first portion is less that a diameter of the second portion.

In accordance with any of the preceding aspects, a modulus of resilience of the first portion being higher than a modulus of resilience of the second portion.

In accordance with any of the preceding aspects, the waveguide device further comprises an E-bend assembly connected the power receiving end of the housing.

In accordance with any of the preceding aspects, the elongated absorber element includes a tapered side extending from the second end of the elongated housing to the first end of the elongated housing so that a thicker end of the elongated absorber element is positioned at the second end of the housing.

In accordance with any of the preceding aspects, the elongated absorber element extends for substantially an entire length of the elongated housing.

In accordance with any of the preceding aspects, the elongated absorber element is a first absorber element and the interior surface of the housing is a first interior side wall of the housing. The first elongated absorber element is disposed against the first interior side wall of the elongated housing. The waveguide device further comprises a second elongated absorber element. The second absorber element is disposed against a second interior side wall of the elongated housing. The second interior side wall is arranged opposite to the first interior side wall of the second interior side wall housing.

In accordance with any of the preceding aspects, the waveguide device further comprises at least one cooling system attached at an exterior surface of the elongated housing and being thermally coupled to said housing.

In accordance with any of the preceding aspects, the at least one cooling system includes a fluid circulation path configured for circulating a cooling liquid. The cooling liquid is configured for absorbing heat from the elongated housing.

In accordance with any of the preceding aspects, the cooling liquid is water.

In accordance with any of the preceding aspects, the power receiving end includes a flange radially extending from the elongated housing.

In accordance with any of the preceding aspects, the flange includes an O-ring configured to seal a space between the flange and a transmission line of a waveguide system.

In accordance with any of the preceding aspects, the absorber element extends along the extent of an interior side wall of the housing.

In accordance with any of the preceding aspects, the elongated housing includes two opposite broad interior walls and two opposite narrow interior walls. The interior surface of the housing is a first narrow interior wall of the opposite narrow interior walls. The projection extends through a first broad interior wall into the passage, and the absorber element is positioned against the first narrow interior wall.

In accordance with any of the preceding aspects, the waveguide device may be a waveguide termination device, and the second end may be a closed end.

In accordance with any of the preceding aspects, the second end includes a flange radially extending from the elongated housing, the flange being configured to be connected to a transmission line of a waveguide system.

In accordance with any of the preceding aspects, the waveguide device may further comprise a spring connecting the closed end to a first end of the elongated absorber element. A stopper may be positioned at a second end of the elongated absorber element and is configured to exert a force on the first end of the elongated absorber element such that the second end of the elongated absorber is configured to be stopped at the stopper.

According to a second aspect, the disclosure relates to a multi-way waveguide combiner. The combiner comprises one or more waveguide devices as defined in any of the preceding aspects.

According to a third aspect, the disclosure relates to a waveguide system. The waveguide comprises one or more waveguide devices as defined in any of the preceding aspects.

According to a fourth aspect, the disclosure relates to a method of manufacturing a waveguide device. The method comprises: providing an elongated absorber element; providing an elongated housing including a first end and a second end. The first end is a power receiving end. The elongated housing defines a hollow passage. A traversal projection extends from the elongated housing into the passage. The projection and an interior surface of the elongated housing define a space shaped to snugly receive the elongated absorber element. The method also comprises sliding the elongated absorber element into a space defined by the transversal projection and the passage such that the transversal projection exerts a resilient force against the absorber element to urge the absorber element against the interior surface of the housing.

In accordance with any of the preceding aspects, the projection is part of a distal end of a screw extending from the housing into the hollow passage.

In accordance with any of the preceding aspects, providing the elongated housing comprises inserting the screw into an aperture formed on an outer surface of the elongated housing so that the part of the distal end that corresponds to the projection extends into the passage.

In accordance with any of the preceding aspects, the method further comprises connecting an E-bend assembly to the power receiving end of the housing.

In accordance with any of the preceding aspects, the method further comprises attaching at least one cooling system at an exterior surface of the housing.

In accordance with any of the preceding aspects, the elongated housing includes two opposite broad interior walls and two opposite narrow interior walls. The interior surface of the housing is a first narrow interior wall of the two opposite narrow interior walls. The projection extends through a first broad interior wall into the passage. The sliding the elongated absorber element into the passage includes positioning the absorber element against the first narrow interior wall so that it is wedged between the first narrow interior wall and the projection.

All features of exemplary embodiments which are described in this disclosure and are not mutually exclusive can be combined with one another. Elements of one embodiment or aspect can be utilized in the other embodiments/aspects without further mention. These and other aspects of this disclosure will now become apparent to those of ordinary skill in the art upon review of a description of embodiments that follows in conjunction with accompanying drawings.

### BRIEF DESCRIPTION OF THE DRAWINGS

Reference will now be made, by way of example, to the accompanying drawings which show example embodiments of the present application, and in which:

FIG. 1A is a perspective view of an example waveguide termination device in accordance with specific non-limiting embodiment;

FIG. 1B is an exploded view of the waveguide termination device of FIG. 1A;

FIG. 1C is a schematic view illustrating how a projection engages and urges an absorber element against an interior surface of a housing of the waveguide termination device of FIGS. 1A and 1B;

FIG. 1D is a zoomed in view illustrating a projection extending into a passage of a housing of the waveguide termination device of FIGS. 1A to 1C;

FIG. 1E is a zoomed in view illustrating an absorber element being pressed against a projection in a passage of a housing of the waveguide termination device of FIGS. 1A to 1C;

FIG. 2A is a side view of an example screw including a projection of the type shown in FIG. 1D in according with a specific example of implementation;

FIG. 2B is a side view of an alternative example of a screw including a projection in accordance with alternative example embodiments;

FIG. 2C is a perspective view of an example pin including a projection in accordance with alternative example embodiments;

FIG. 2D is a perspective view of an example of a set screw including a projection in accordance with alternative example embodiments;

FIG. 2E is a perspective view of an example bracket including a projection in accordance with alternative example embodiments;

FIG. 3A is a top plan view of an example absorber element that may be used in the waveguide termination device depicted in FIGS. 1A to 1C;

FIG. 3B is a front view of the example absorber element of FIG. 3A;

FIG. 4 is an example method of assembling the waveguide termination device of FIG. 1A in accordance with a non-limiting example of implementation.

Similar reference numerals may have been used in different figures to denote similar components.

In the drawings, embodiments are illustrated by way of example. It is to be expressly understood that the description and drawings are only for purposes of illustrating certain embodiments and are an aid for understanding. They are not intended to be a definition of the limits of the invention.

### DESCRIPTION OF EXAMPLE EMBODIMENTS

A detailed description of one or more specific embodiments of the present disclosure is provided below along with accompanying Figures that illustrate principles of the invention. The invention is described in connection with such embodiments, but the invention is not limited to any specific embodiment. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

Similar reference numerals may have been used in different figures to denote similar components.

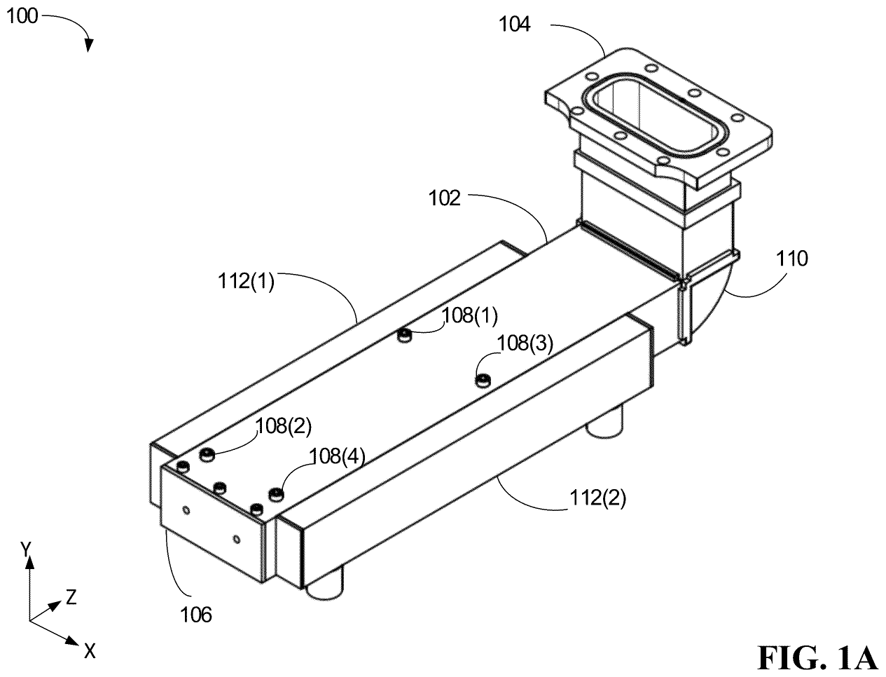

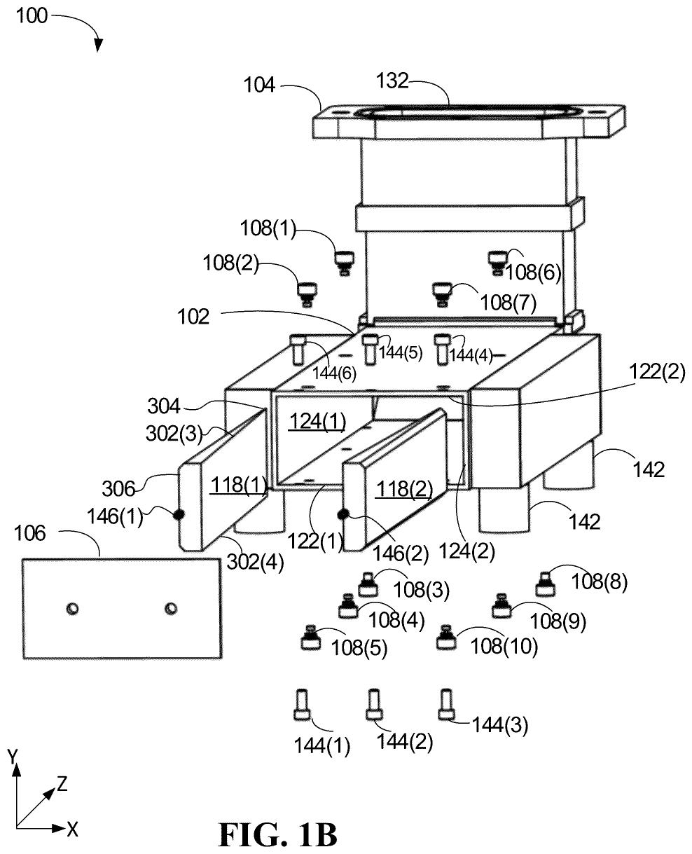

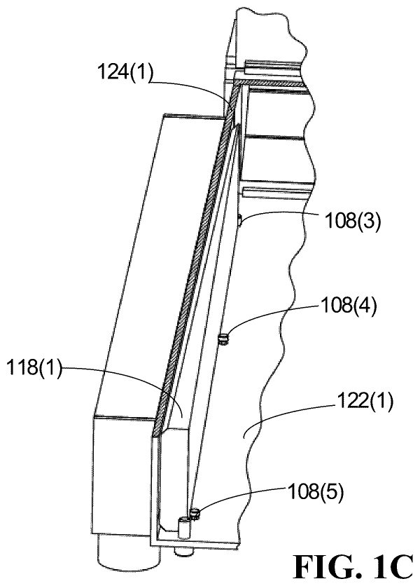

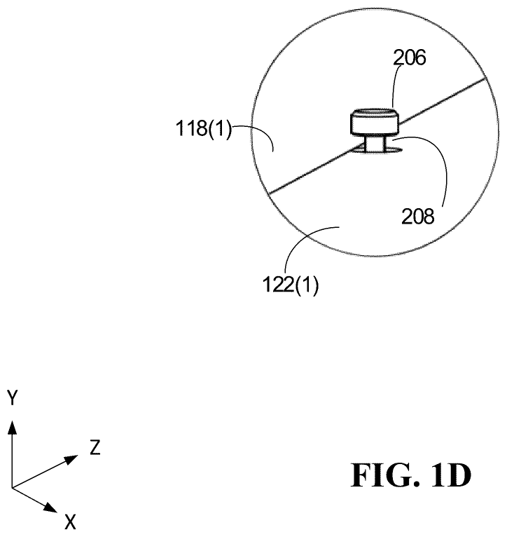

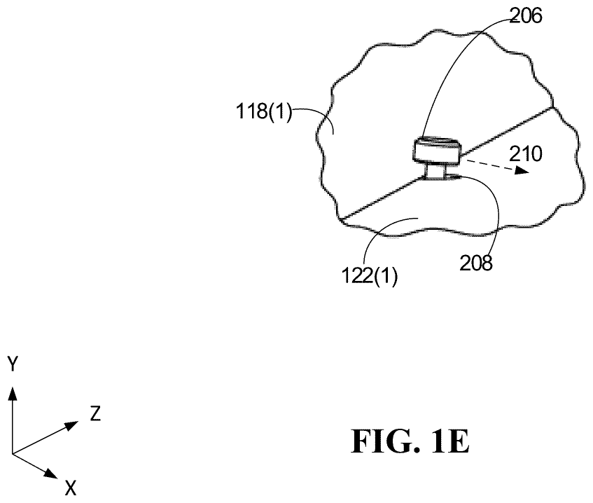

FIGS. 1A-1C illustrate an example waveguide termination device 100, which absorbs electromagnetic waves traveling through the waveguide termination device 100 and generates absorbed heat, in accordance with an example embodiment. As shown, the waveguide termination device 100 includes an elongated housing 102, a first and second elongated absorber element 118(1), 118(2) (generically referred to as absorber element 118), and a plurality of projections 108(1)-(10) (generically referred to as projection 108). The elongated housing 102 incudes a first and a second end. The first end is a power receiving end 104, which is configured to be connected to a waveguide circuit and which receives electromagnetic waves transmitted from a transmission line of a waveguide. In one possible configuration, the power receiving end 104 may incorporate a flange radially extending from the housing 102. The flange is configured to be coupled to the transmission line of the waveguide circuit. In some examples, an O-ring 132 may be provided around the flange to seal a space between the flange and the transmission line of the waveguide circuit. The second end of the elongated housing 102 is a closed end 106, which terminates a transmission path of the electromagnetic waves that are received at the power receiving end 104.

As best see in FIG. 1B, the elongated housing 102 defines a hollow passage through which the received electromagnetic waves travel. In this very specific example, the hollow passage has a generally rectangular cross section. In this example, the elongated housing 102 comprises a first and second broad interior walls 122(1), 122(2) (generically referred to as broad interior wall 122) and a first and second narrow interior walls 124(1), 124(2) (generically referred to as narrow interior wall 124) that are opposite with respect to each other. The first and second broad interior walls 122(1), 122(2) are spaced apart and opposite with respect to each other. Similarly, the first and second narrow interior walls 124(1), 124(2) are spaced apart and opposite with respect to each other. Although an example waveguide termination device with a rectangular cross section is illustrated in the Figures and discussed below, this in only illustrative and is not intended to be limiting. In other examples, the cross section of the hollow passage may have any other suitable shape, such as square, circular, oval, or curved. In addition, while an example waveguide termination device with two absorber elements 118 has been described, it is to be appreciated that alternative configurations may include a different number of absorber elements including one (1) absorber element, three absorber elements or more absorber elements.

In specific practical implementations, the housing 102 may be made of conductive metal, such as for example, but without being limited to, aluminum, copper, brass, bronze, or invar. This is illustrative and is not intended to be limiting. In other possible configuration, the housing 102 may be made of any suitable material that provides a passage to transmit electromagnetic waves.

The first and second absorber elements 118(1), 118(2) positioned within the housing 102 act as loads to enable the impedance of the waveguide termination device 100 to be matched with that of the transmission line of the waveguide circuit and to absorb at least part of the energy of the electromagnetic wave traveling through the passage of the housing 102. FIGS. 1B and 1C depict the first and second absorber elements 118(1), 118(2) that are elongated and that are disposed within the passage of the housing 102 along interior surfaces (e.g., the first and second narrow interior walls 124(1), 124(2)) of the housing 102. In particular, as shown in FIG. 1C, the first absorber element 118(1) is placed against the first narrow interior wall 124(1) within the housing 102. Similarly, a second absorber element 118(2) as shown in FIG. 1B is disposed along the second narrow interior wall 124(2) inside the housing 102. Manners for securing the first and second absorber element 118(1), 118(2) to a corresponding narrow interior wall 124 will be discussed further below. In this example, the absorber elements 118 may be made of or filled with lossy material, such as silicon carbide, ceramic, lossy resin, or various other known lossy material that can be used in lieu of the lossy material.

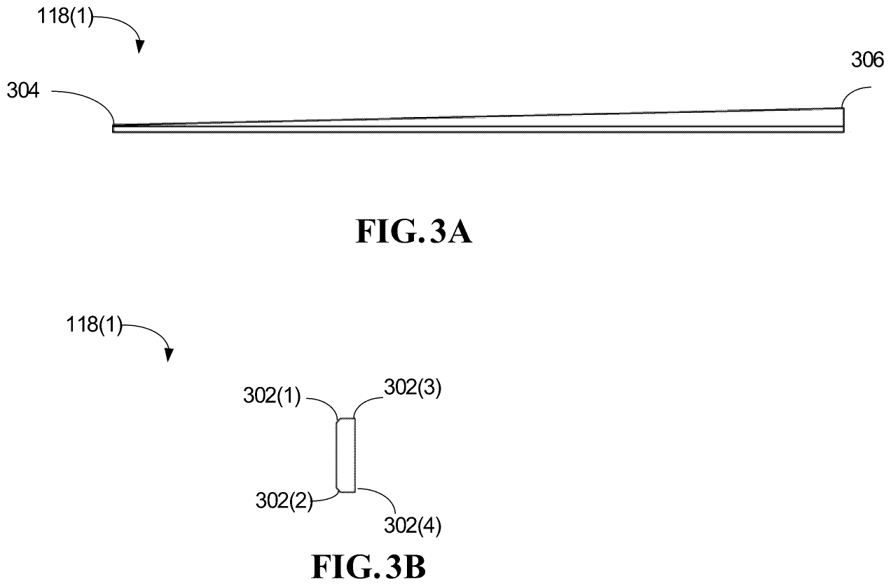

Specific examples of configurations (e.g., shape, orientation, and/or placement) of an example absorber element 118 will now be described with reference to FIGS. 1B, 3A, and 3B. Taking the first absorber element 118(1) as presented in FIG. 1B for example, the first absorber element 118(1) includes a tapered side which extends from the closed end 106 to the power reviewing end 104, where the first absorber element 118(1) is thicker near the closed end 106 and progressively becomes narrower towards the power reviewing end 104. In particular, FIGS. 3A and 3B depict a configuration of the first absorber element 118(1). In the example of FIGS. 1B and 3A, the first absorber element 118(1) includes a first end 306 and a second end 304. The first end 306 is proximal to the closed end 106, and the second end 304 is close to the power receiving power end 104. The first end 306 has a thickness which gradually becomes thinner towards the second end 304. As the second end 304, the thinner portion of the absorber element 118(1) and which is closer to the power receiving end 104, may aid in absorbing, rather than reflecting, the electromagnetic waves that are received at the power receiving end 104. Thus, a tapered shape of the absorber element 118 may enable unwanted reflections to be minimized significantly, compared with cuboid shaped absorber element. As illustrated in FIG. 1B, in this embodiment, a height and a length of the absorber element 118 are generally the as those of the narrow interior wall 124. FIGS. 1B and 3B show a configuration of an exterior surface of the first absorber element 118(1). The exterior surface that faces to the narrow interior wall 124(1) includes a pair of corners 302(1), 302(2) each of which is cut at an angle so as to better fit onto the narrow interior wall 124(1). In various non-limiting embodiments of the present disclosure, the first absorber element 118(1) may have any suitable configuration, for example including material, shape, height, length, and/or height. For example, the first absorber element 118(1) may not be tapered in alternative embodiment and may, for example, have a same width throughout. As another example, the first absorber element 118(1) may be a cylinder. In some applications, the second absorber element 118(2) may have a configuration (e.g., material, shape, height, length, and/or length) that is identical to that of the first absorber element 118(1). However, a different configuration of the second absorber element 118(2) is possible and the disclosure is not limited to a particular configuration. In other examples, the number of the absorber elements 118 may be varied. That is, only one single absorber element (e.g., the first absorber element 118(1) or the second absorber element 118(2)) may reside within the housing 102. Alternatively, more than two absorber elements may reside within the housing 102.

Specific examples of manners of securing the first and/or second absorber element 118 to the corresponding narrow interior wall 124, using the plurality of projections 108(1)-108(10), will be now described in greater detail with reference to FIGS. 1B and 1C. As shown in FIG. 1C, taking a projection 108(4), the projection 108(4) extends from the first broad interior wall 122(1) into the passage of the housing 102. When the absorber element 118(1) is in place, the projection 108(4) is configured to exert a resilient force on the absorber element 118(1) to urge the absorber element 118(1) against the interior surface (i.e., the first narrow interior wall 124(1)) of the housing 102.

It should be appreciated that the projection 108(4) is discussed below as a representative of the plurality of projections 108(1)-108(10) for ease of illustration. That is, configurations of the plurality of projections 108 may be identical to that of the projection 108(4). However, it is not intended to be limiting. In other examples, a respective configuration (e.g., shape, material, and/or size) of each projection 108 may be different so long as the projection 108 has the ability to exert a respective resilient force on the absorber element 118. In some implementations (not shown in the Figures), the projection 108(4) may be formed directly on an internal wall of the housing, so that the projection and the housing form a unitary component, using any suitable machining technique to create the projection. The projection may have any suitable shape so that the projection and an interior surface of the elongated house define a space configured to snugly receive the elongated absorber element. It is not intended to be limiting. The integration process to include the projection 108 into the housing 102 may be implemented using any other suitable method known in the art. In addition, although the absorber elements 118 being urged against the corresponding narrow interior wall 124 are depicted in the present disclosure, it is illustrative and not intended to be limiting. In other possible configurations, the absorber elements 118 may instead be urged against the two broad interior walls 122 by projections extending from the narrow interior walls 124.

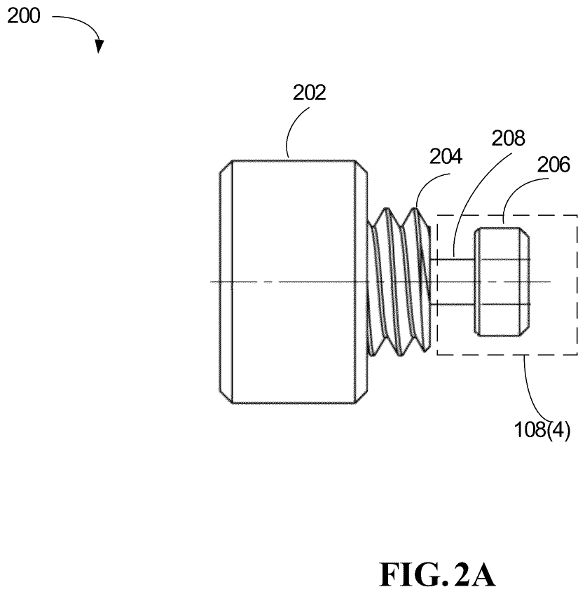

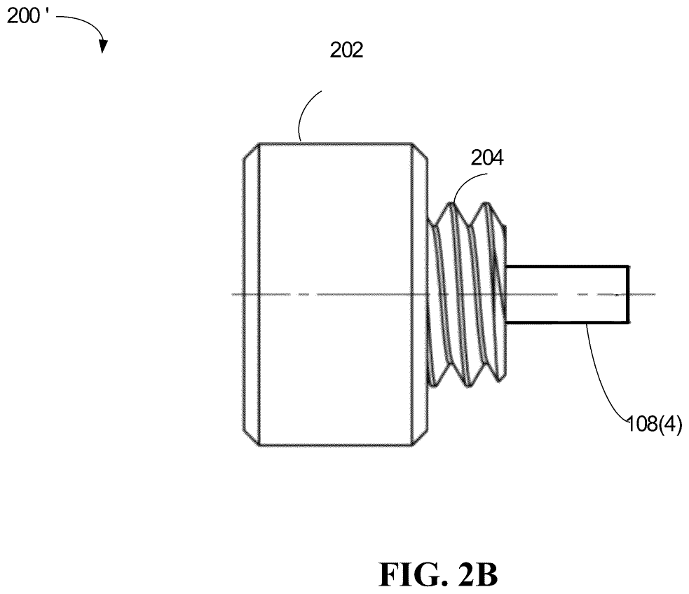

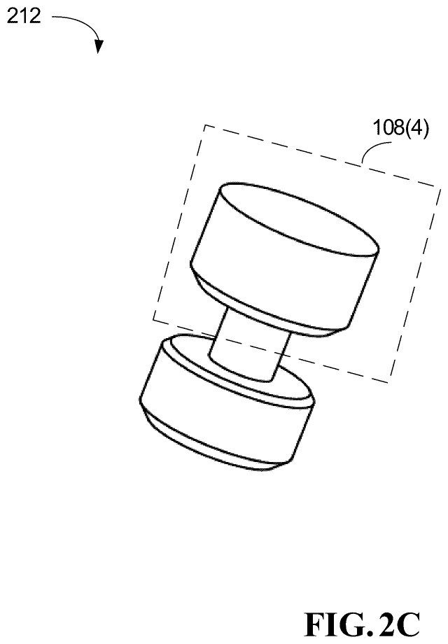

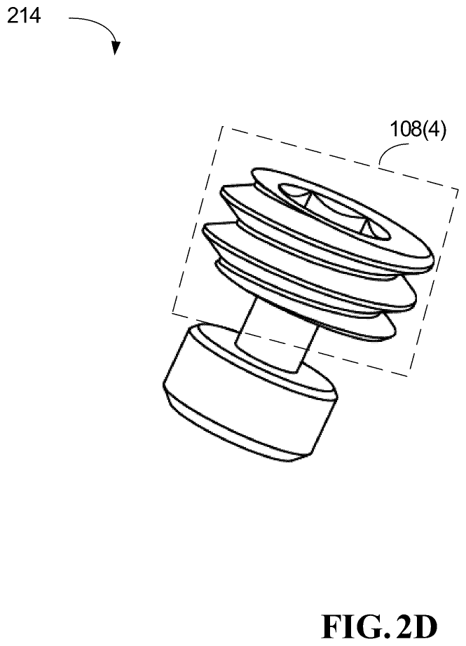

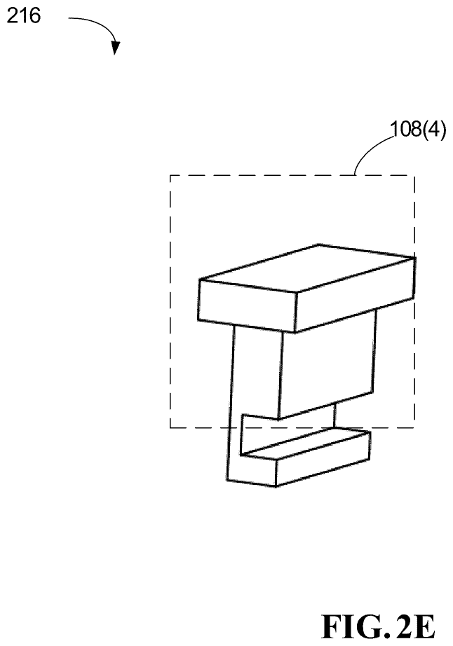

In some other implementations, the projection 108(4) may be a part of a distal end of a screw extending from the housing into the hollow passage, wherein the screw is inserted through an aperture formed on an outer surface of the elongated housing 102 so that the part of the distal end of the screw corresponding to the projection extends into the passage. FIG. 2A shows a side view of an example screw 200, which the projection 108(4) is part of a distal end thereof, in accordance with an example of implementation. In the example depicted, the screw 200 includes a proximal end (e.g., screw head 202), a threaded component 204 and a projection 108(4). In the example depicted, the projection 108(4) includes a resilient portion 208 and an end piece 206. Optionally, the end piece 206 may be secured to the resilient portion 208 in the projection 108(4) extending from the housing into the hollow passage. As illustrated in FIG. 2A, a diameter of the end piece 206 is greater than a diameter of the resilient portion 208, which may help to increase a contact area between the projection 108(4) and the absorber element 118. Thus, a resilient force occurring at the contact area between the projection 108(4) and the absorber element 118 may be applied to the absorber element firmly. Additionally, the diameter of the end piece 206 being greater than the diameter of the resilient portion 208 may help to prevent an edge of the absorber element 118 from being damaged when the absorber element 118 is inserted through a space defined by the projections and the interior surface of the housing 102. In this example, the components of the screw 200 are made of same identical material, such as conductive metal (e.g., aluminum, copper, brass, bronze, or invar). In particular, aluminum may be used for the screw to allow dip brazing. In some other examples, other more flexible material may be used to constitute the screw, such as beryllium copper for example. A diameter of the resilient portion 208 of the projection 108(4) is less than that of the threaded component 204, which provides an elasticity or resiliency of the resilient portion 208 of the projection 108(4) to be increased relative to that of the threaded component 204. That is, the differentiated diameter between the resilient portion 208 of the projection 108(4) and the threaded component 204 enables a different resiliency to be obtained, which leads to a resilient force being exerted on the first absorber element 118(1) such that the first absorber element 118(1) is urged against the first narrow interior wall 124(1) of the housing 102. In other possible configurations, a first material that constitutes the resilient portion 208 of the projection 108(4) may be different than a second material that forms the threaded component 204. In such implementations, a modulus of resilience of the first material may be higher than that of the second material. Thus, the resilient force is generated when the first absorber element 118(1) comes into contact with, and is pressed upon, the screw 200.

Reference is now made with respect to FIGS. 1D and 1E, which illustrate how the projection 108(4) exerts the resilient force on the first absorber element 118(1). As presented in FIG. 1D, the projection 108(4) extends from the first broad interior side wall 122(1) upwardly, and the end piece 206 of the projection abuts onto the projection 108(4) (shown in FIG. 2A). In the examples of FIGS. 1D and 1E, a diameter of the end 206 is greater than that of the resilient portion 208 of the projection 108(4). Initially, when the absorber element 118(1) is inserted into a space defined between the first narrow interior wall 124(1) and the projection 108(4), the end piece 206 is in contact with the absorber element 118(1). As depicted in FIG. 1E, when the absorber element 118(1) is snugly received by the space, the absorber element 118(1) then applies a pressing force onto the projection 108(4), which causes the projection 108(4) to be bent slightly in a direction 210. In return, the projection 108(4) exerts a resilient force oriented in the opposite direction (opposite to the direction 210) on the absorber element 118(1) to urge the absorber element 118(1) against the first narrow interior wall 124(1) of the housing 102. The resilient force is generally commensurate with the pressing force applied by the absorber element 118(1) onto the projection 108(4).

In contrast to the use of braising techniques and adhesives, which are prone to cracking and/or breaking under high temperature conditions, by using the projection 180 to the absorber elements 118 against an interior wall of the housing, permanent attachments can be avoided to improve the flexibility of the waveguide termination device without reducing performance (e.g., high power handling capability, low VRSW, broad operation frequency) of the waveguide termination device. For example, physical damages (e.g., broken or cracking) may be prevented because the housing 102 (e.g., the narrow interior walls) can expand more freely without causing impact on their thermal connection with the absorber elements. Furthermore, as the resilient force, rather than any permanent approaches, enables the absorber element 118 to be in contact with the side walls of the housing, the absorber element 118 may be readily replaced with a new absorber element 118 in the case of breakage and/or when an absorber element 118 with different proprieties is desired. In a case where operation frequency or any characteristic of the waveguide termination device is required to change, the waveguide termination device can be easily adapted by substituting the absorber element 118. It is noted that sliding the absorber element 118 into the housing is a simpler process, compared with using adhesives or braising techniques. Hence, hardware costs for operating a waveguide system overall may be reduced.

In addition, as the absorber elements 118 are urged to be in contact with the narrow interior walls 124 of the housing 102, such contact establishes thermal conduction paths that transfer heat from the absorber elements 118 to interior side walls (e.g., the first and second narrow interior walls 124(1), 124(2)) of the housing 102, which may enable absorbed heat to be conducted to the housing 102 more easily.

In the example of FIG. 2A, although the end 206 of the projection 108(4) placed at the distal end of the projection 108(4) is a cylinder, and the diameter of the end 206 is greater than that of the resilient part 208 of the projection 108(4), this is illustrative and is not intended to be limiting for all embodiments. In other examples, the diameter of the projection 108(4) may remain substantially the same throughout provided the projection 108(4) has a certain level of resiliency to exert a resilient force on the absorber element 118. FIG. 2B presents an alternative example screw 200′ in accordance with alternative example embodiments. Components of the screw 200′ in FIG. 2B are similar to those of the screw 200 of FIG. 2A except that the resilient portion 208 of the projection 108(4) extends to the distal end of the screw 200′ and omits the end piece 206 that has a larger diameter. In such case, the resilient portion of the projection 108(4) is in direct contact with the absorber element 118(1) to exert the resilient force on the absorber element 118(1).

As shown in FIGS. 2A and 2B, the screw 200 200′ may be inserted through an aperture formed on an outer surface of the elongated housing 102 so that the part of the distal end of the screw 200 200′ corresponding to the projection 108(4) extends into the hollow passage.

In the example of FIG. 1B, are illustrated ten (10) projections 108(1)-108(10) that extend from interior surfaces of the housing 102 into the hollow passage defined by the housing 102. In particular, five (5) projections extend from the broad interior wall 122 into the passage to exert five (5) different respective resilient forces to the absorber element 118(1). For example, a first projection 108(1) and a second projection 108(2) extend through the second broad interior wall 122(2) (i.e., upper interior surface of the housing 102) and are spaced apart from one another. The first projection 108(1) is positioned at a first location along an extent of the absorber element 118(1), such as in proximity to an edge 302(3) of the absorber element 118(1). Likewise, the second projection 108(2) is positioned at a second location along the edge 302(3) of the absorber element 118(1) as shown in FIG. 1B. In this example, as the absorber element 118(1) taps from the closed end 106 to the power receiving end 104 at a taper angle, the first and second projection 108(1)-118(2) are arranged in a line (e.g., in X-Z plane) that is inclined in an angle with respect to an interior side wall (e.g., the first narrow interior wall 124(1)) of the housing 102. The angle of the line on which the first and second projection 108(1)-118(2) are arranged substantially matches the taper angle of the absorber element 118(1). Similarly, a third, fourth, fifth projection 108(3)-118(5) are spaced apart and positioned at respective locations along another (lower) edge of the absorber element 118(1)(e.g., an edge 302(4) at bottom right corner of the absorber element 118(1) of FIG. 1B). The third, fourth, fifth projection 108(3)-118(5) are arranged in a line that is inclined at an angle that substantially matches the taper angle of the absorber element 118(1) as well. In the example of FIG. 1B, five (5) projections in total 108(1)-118(5) are employed to urge the absorber element 118(1) against the first narrow interior wall 124(1), and another five (5) projections 108(6)-118(10) are utilized to urge the other absorber element 118(2) against the second narrow interior wall 124(2). However, it is to be appreciated that different numbers of projections and different geometric arrangements of the projections may be possible in alternative suitable implementations and the disclosure is not limited to a particular number or arrangement of projections. In other possible configuration, the total number of projections used to provide the resilient forces to each of the absorber elements 118 may be any number that is greater than 1. Furthermore, although the cardinality of projections 108(1)-108(5) for the absorber element 118(1) is illustrated to be identical to that of the absorber element 118(2), the number of projections corresponding to the two absorber elements that are opposite with respect to each other may be different. For example, the cardinality of the projections 108 corresponding to the first narrow interior wall 124(1) may be 1, and the cardinality of the projections 118 corresponding to the second narrow interior wall 124(2) may be 6.

It is noted that, although the projection 108(4) is illustrated as a part of an example screw 200 200′ above, this is only illustrative. By way of another non-limiting example, in one possible configuration, the projection 108(4) may be a part of a screw which does not have a screw head (not shown in the figures). In yet other alternative examples, the projection 108(4) may be a part of a pin (e.g., press fit pin, slide fit pin, or soldered pin) or a solder bracket, etc. FIG. 2C illustrates an example pin 212 which includes the projection 108(4). FIG. 2D shows detailed configurations of an example set screw a part of which is the projection 108(4). FIG. 2E demonstrates an example solder bracket which includes the projection 108(4). Accordingly, it should be appreciated that the projection 108(4) could be a part of any appropriate configuration that extends from the interior surfaces of the housing.

Returning to FIG. 1B, it is noted that the projections 108 help to urge the absorber elements against the narrow interior walls firmly along a Y-Z plane. In some implementations, a first and a second spring 146(1), 146(2) (generically referred to as spring 146) may be included within the waveguide termination device 100 to secure the absorber elements along a Y-Z plane. In particular, the first spring 146(1) may provide an interface between the closed end 106 to the first end 306 of the for example. In some examples, the spring 146(1) may be affixed to the closed end 106. When the absorber element 118(1) is inserted within the housing 102, the spring 146(1) enters into contact with the first end 306 of the absorber element 118(1) and applies a resilient force on the absorber elements in a direction along Z axis. Optionally, a stopper may be positioned so as to enter into contact with the second end 304 of the absorber element 118(1) to prevent the absorber element from sliding too far along the housing in the Y-Z plane. In the example of FIG. 1B, the third projection 108(3) acts as the stopper that enters into contact with the second end 304 of the absorber element 118(1) such that the absorber element 118(1) is prevented from moving too far when the spring 146(1) exerts a force on the first end 306 of the absorber element 118(1). This above is only illustrative and other configurations are possible. In alternative examples, the spring 146(1) may be affixed to the first end 306 of the absorber element, and the closed end 106 enters into contact with the spring 146(1) after the absorber element 118(1) slides into the housing 102. In some embodiments, the second spring 146(2) may have a configuration that is substantially identical to the configuration of the first spring 146(1). However, different configurations are possible, and the disclosure is not limited to specific configurations of the springs 146 or stopper and some embodiments may omit the spring and/or the stopper.

Referring back to FIG. 1A, the waveguide termination device 100 may further comprise one or more optional cooling systems 112(1), 112(2)(generically referred to as cooling system 112). Each cooling system 112 may mounted to an exterior narrow wall of the housing 102 by any suitable techniques (e.g., adhesive, soldering, or brazing). As illustrated in the specific example of FIG. 1A, each cooling system 112 includes a fluid circulation path that may be coupled to an external circulation system and configured to circulate a cooling liquid. The cooling liquid absorbs heat that is transferred from the housing 102. The cooling liquid may be water because of its low cost and high heat absorbing capacity. In other possible configurations, various other fluids, including ethylene, propylene glycol mixture, air, liquid nitrogen or another suitable fluid may be used. In this example, a height and a length of each cooling system are substantially same to those of the narrow interior wall 124 of the housing. In other possible configurations, the height and the length of each cooling system may be varied. The cooling system is discussed as an example to absorb heat from the elongated housing 102. In various non-limiting embodiments of the present disclosure, one or more heat sink or any other cooling system may be used to absorb or transfer the heat from the elongated housing 102. Moreover, in a scenario that the waveguide termination device 100 is used in a low power application, the cooling system or the heat sink may be omitted and generated heat may be radiated efficiently by the housing 102 itself in the low power application.

In some examples, the waveguide termination device 100 may incorporate a E-bend assembly 110 which is connected to the power receiving end 104 of the housing 102. The E-bend assembly 110 helps to change or distort E-filed of the electromagnetic waves transmitted from the transmission line of the waveguide. By way of non-limiting example, in one alternative possible configuration (not shown in the Figures), the waveguide termination device 100 may include a H-bend assembly, a straight waveguide, or other types of waveguides.

In alternative examples, as shown in FIG. 1B, the waveguide termination device 100 may include one or more support members 142 that provide support for the waveguide termination device 100. As the one or more supports 142 provide a space between the housing 102 and ground, heat on the first broad interior wall 122(1) may be radiated and conducted to the ambience of the housing 102 quicker, which may further help to remove the absorbed heat from the housing 102.

As shown in FIG. 1B, the closed end 106 may be attached to the housing 102 by one or more screws 144(1)-144(6) or other suitable fastener(s). This is an example and is not intended to be limiting. In other examples, any suitable method may be used to attach the closed end 106 to the housing 102.

In some applications, one or more waveguide termination devices 100 as discussed in the present disclosure may be included in a multi-way waveguide combiner or other waveguide circuit, in order to achieve a desired characteristic (e.g., broad operation frequency and/or low VSRW) for the waveguide combiner or circuit. For example, an 8-way waveguide combiner may include seven waveguide termination devices (e.g., the waveguide termination device 100 as described in the present disclosure) to absorb electromagnetic waves transmitted from their respective combiner waveguide port.

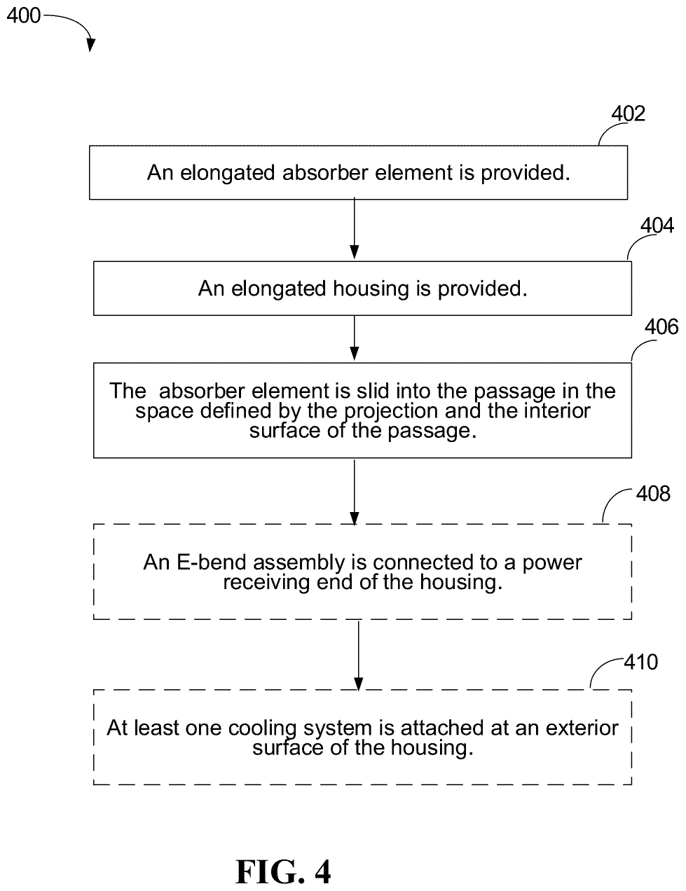

FIG. 4 illustrates an example method 400 of assembling the waveguide termination device 100 in accordance with a specific embodiment. As depicted, the method 400 comprises:

At step 402, an elongated absorber element is provided. The elongated absorber element may be the first or second elongated absorb element 118(1) or 118(2) as discussed above.

At step 404, an elongated housing is provided. Taking the elongated housing 102 as shown in FIG. 1B for example, the elongated housing 102 includes a first end 104 and a second end 106. The first end 104 is a power receiving end and the second end 106 is a closed end. The elongated housing 102 defines a hollow passage through which electromagnetic waves travel. A projection 108 extends from the elongated housing 102 into the passage. The projection 108 and an interior surface of the elongated housing 102 define a space shaped to snugly receive the elongated absorber element 118. In some applications, the elongated housing 102 is manufactured to be a unitary structure with the first, second, third, fourth, and fifth projections 108(1)-108(5) extending from interior surfaces (e.g., the first and second broad interior walls 122(1), 122(2)) of the housing 102. That is, each projection 108 is manufactured to be integrated with the housing 102.

In alternative examples, the five projections 108(1)-108(5) are manufactured separately from the housing 102, and then assembled, such as inserted, with the housing 102 when necessary. For instance, each projection 108 (e.g., the projection 108(4)) is part of a screw (e.g., the screw 200 as shown in FIGS. 2A or 2B), and the screw 200 is driven through an aperture into the passage. The screw 200 may be soldered with the housing 102 to prevent air leakage from the passage. In a case where the end piece 206 exist, the end piece 206 is then secured to the projection 108 once the projection is manufactured or assembled to extend from the interior surfaces of the housing.

At step 406, the absorber element is slid into the passage in the space defined by the projection and the interior surface of the passage. Once the five projections 108(1)-108(5) are manufactured or assembled to extend into the passage of the housing 102, the first absorber element 118(1) is then slid into a space defined by the first narrow interior wall 124(1), the first and second broad interior wall 122(1), 122(2), and the five projections 108(1)-108(5). Therefore, each of the five projections 118(1)-118(5) exerts a corresponding resilient force on the first absorber element 118(1) to urge the first absorber element 118(1) against the first narrow interior wall 124(1) of the housing 102.

At optional step 408, an E-bend assembly is connected to a power receiving end of the housing. For instance, standard brazing techniques or any suitable techniques may be utilized to connect the E-bend assembly to the power receiving end of the housing.

At step 410, alternatively, at least one cooling system is attached at an exterior surface of the housing. An approach for the attaching may include adhesive, brazing, or any suitable manners. In some applications, the cooling system may be replaced with one or more heat sink. It should be appreciated that although the at least one cooling system or heat sink may be used in high power applications, in low power applications, the cooling system and/or heat sink may be omitted.

In some examples, the steps 408 and 410 may be performed before, after, or between the steps 402-406.

The method of sliding the absorber element into a space defined by the projection(s) and the interior surface of the elongated housing such that the absorber element can be snugly received by the space. Thus, the absorber element can be urged against interior narrow walls of the housing firmly without using any permanent attaching techniques. Thus, physical damages that would otherwise be caused by thermal expansion of the housing when absorber elements are secured by an adhesive of by brazing may be avoided using the approach described herein. Furthermore, flexibility of substituting the absorber element may be improved significantly. It is to be appreciated that any suitable absorber element 118 may be used in practical implementations to achieve a desired characteristic of the waveguide termination device, for example including a desired operation frequency of the electromagnetic waves, a desired VSWR, or a desired size of the housing. Such a method enables a waveguide termination device to be manufactured, constructed, and/or assembled with relative simplicity and flexibility.

It should be understood that although specific materials, shape, and/or size are discussed above with respect to each of the housing 102, the absorber elements 118, and/or the projections 108, in some other configurations, other suitable material, shape, and/or size may be utilized in the configurations discussed in FIGS. 1A-4. It should be appreciated that although a waveguide termination device with a closed end is described in great detail in the present disclosure to terminate transmission of electromagnetic waves traveling through the hollow passage of the housing, this is only illustrative and other embodiments may be contemplated. In other examples, the second end 106 of the housing 102 may include a flange, rather than a closed end. The flange of the second end 106 may radially extend from the second end of the housing and may be configured to be connected/coupled to another transmission line of the waveguide system. In that case, the second end 106 may act as a transmitting end to transmit the electromagnetic waves traveling through the hollow passage of the housing to the other transmission line. The absorber elements 118 in such an embodiment act as attenuators to alter the power of the electromagnetic waves in a desired manner. Therefore, the device 100 may be a waveguide device 100 which is implemented to adjust the power of electromagnetic waves rather than a waveguide termination device 100. In various non-limiting embodiments of the present disclosure, the device 100 could be any device to absorb a desired amount of power of the electromagnetic waves using configurations of the absorber elements 118 and the projections 108.

Although the present disclosure describes methods and processes with steps in a certain order, one or more steps of the methods and processes may be omitted or altered as appropriate. One or more steps may take place in an order other than that in which they are described, as appropriate.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

1. A waveguide device comprising:
an elongated housing including a first end and a second end, wherein the first end is a power receiving end, the elongated housing defining a hollow passage;
an elongated absorber element disposed within the passage of the housing along an interior surface of the housing, wherein the absorber element is configured to absorb at least some energy of electromagnetic waves traveling through the hollow passage; and
a projection extending from the elongated housing into the passage, wherein the projection is configured to exert a resilient force on the absorber element to urge the absorber element against the interior surface of the housing.

2. The waveguide device of claim 1, wherein the projection extending into the passage is a first projection, the first projection being positioned at a first location along an extent of the elongated absorber element, the waveguide termination device further comprising a second projection extending from the elongated housing into the passage, the first and second projections being spaced apart from one another, the second projection being positioned at a second location along the extent of the elongated absorber element, the second projection being configured to exert a second resilient force on the elongated absorber element to urge the elongated absorber element against the interior surface of the housing.

3. The waveguide device of claim 1, wherein the projection extending into the passage is one of a plurality of projections extending from the elongated housing into the passage, the projections in the plurality of projections being positioned at respective locations along an extent of the elongated absorber element, the plurality of projections being spaced apart from one another, the plurality of projections being configured to exert resilient forces on the elongated absorber element to urge the elongated absorber element against the interior surface of the housing, wherein the plurality of projections includes at least three projections.

4. The waveguide device of claim 3, wherein the plurality of projections are linearly arranged along the hollow passage.

5. The waveguide device of claim 4, wherein the elongated absorber element has a tapered profile and wherein the plurality of projections are linearly arranged at an angle along the hollow passage, wherein the angle matches the tapered profile of the absorber element.

6-10. (canceled)

11. The waveguide device of claim 1, wherein the projection is a part of a distal end of a screw extending from the housing into the hollow passage, wherein the screw is inserted through an aperture formed on an outer surface of the elongated housing so that the part of the distal end of the screw corresponding to the projection extends into the passage.

12. The waveguide device of claim 11, wherein the screw includes a proximal end, a threaded component and the distal end, the threaded component being positioned between the proximal end and the distal end, at least a portion of the projection being characterized by a resilience greater than a resilience of the threaded component of the screw thereby being configured for exerting the resilient force on the absorber element.

13. The waveguide device of claim 12, wherein a diameter of at least the portion of the projection is less than a diameter of the threaded component of the screw.

14. The waveguide device of claim 12, wherein at least part of the projection is made of first material and wherein the threaded component is made of second material, a modulus of resilience of the first material being higher than a modulus of resilience of the second material.

15. The waveguide device of claim 1, wherein the projection includes a first portion and a second portion, wherein a diameter of the first portion is less that a diameter of the second portion.

16. The waveguide device of claim 15, wherein a modulus of resilience of the first portion being higher than a modulus of resilience of the second portion.

17. The waveguide device of claim 1, further comprising an E-bend assembly connected the power receiving end of the elongated housing.

18. The waveguide device of claim 1, wherein the elongated absorber element includes a tapered side extending from the second end of the elongated housing to the first end of the elongated housing so that a thicker end of the elongated absorber element is positioned at the second end of the housing.

19. (canceled)

20. The waveguide device of claim 1, wherein the elongated absorber element is a first absorber element and wherein the interior surface of the housing is a first interior side wall of the housing, the first elongated absorber element being disposed against the first interior side wall of the elongated housing, the waveguide device further comprising a second elongated absorber element, the second absorber element being disposed against a second interior side wall of the elongated housing, the second interior side wall being arranged opposite to the first interior side wall of the second interior side wall housing.

21. The waveguide device of claim 1, further comprising at least one cooling system attached at an exterior surface of the elongated housing and being thermally coupled to said housing.

22. The waveguide device of claim 21, wherein the at least one cooling system includes a fluid circulation path configured for circulating a cooling liquid, the cooling liquid being configured for absorbing heat from the elongated housing.

23. (canceled)

24. The waveguide device of claim 1, wherein the power receiving end includes a flange radially extending from the elongated housing.

25. The waveguide device of claim 24, wherein the flange includes an O-ring configured to seal a space between the flange and a transmission line of a waveguide system.

26. The waveguide device of claim 1, wherein the absorber element extends along the extent of an interior side wall of the housing.

27. The waveguide device of claim 1, wherein the elongated housing includes two opposite broad interior walls and two opposite narrow interior walls, the interior surface of the housing being a first narrow interior wall of the opposite narrow interior walls, the projection extending through a first broad interior wall into the passage, and the absorber element being positioned against the first narrow interior wall.

28. The waveguide device of claim 1, wherein the waveguide device is a waveguide termination device, and the second end is a closed end.

29. The waveguide device of claim 1, wherein the second end includes a flange radially extending from the elongated housing, the flange being configured to be connected to a transmission line of a waveguide system.

30. The waveguide device of claim 28, further comprising:
a. a spring between the closed end and a first end of the elongated absorber element, and
b. a stopper positioned at a second end of the elongated absorber element, the spring being configured to exert a force on the first end of the elongated absorber element such that the second end of the elongated absorber element is urged against the stopper.

31. A multi-way waveguide combiner comprising the waveguide device defined in claim 1.

32. (canceled)

33. A method for assembling a waveguide device, said method comprising:
providing an elongated absorber element;
providing an elongated housing including a first end and a second end, wherein the first end is a power receiving end, the elongated housing defining a hollow passage, wherein a projection extends from the elongated housing into the passage, wherein the projection and an interior surface of the elongated housing define a space shaped to snugly receive the elongated absorber element; and
sliding the elongated absorber element into the passage in the space defined by the projection and the interior surface of the passage such that the projection exerts a resilient force on the elongated absorber element to urge the elongated absorber element against the interior surface of the housing.

34. The method of claim 33, wherein herein the projection is part of a distal end of a screw extending from the housing into the hollow passage.

35. The method of claim 34, wherein providing the elongated housing comprises inserting the screw into an aperture formed on an outer surface of the elongated housing so that the part of the distal end that corresponds to the projection extends into the passage.

36. (canceled)

37. The method of claim 33, further comprising attaching at least one cooling system to an exterior surface of the elongated housing.

38. The method of claim 33, wherein the elongated housing includes two opposite broad interior walls and two opposite narrow interior walls, the interior surface of the housing being a first narrow interior wall of the two opposite narrow interior walls, the projection extending through a first broad interior wall into the passage, wherein sliding the elongated absorber element into the passage includes positioning the absorber element against the first narrow interior wall so that it is wedged between the first narrow interior wall and the projection.
